(19) United States
(12) Patent Application Publication
(10) Pub. No.: US 2008/0158503 A1
(43) Pub. Date: Jul. 3, 2008

(54) Eyewear with forehead-ventilating provisions

(76) Inventor: Scott A. Estrem, Springfield, MO (US)

Correspondence Address: Jonathan A. Bay;Attorney at Law, Suite 314, 333 Park Central East, Springfield, MO, 65806, US

(21) Appl. No.: 11/645,937

(22) Filed: Dec. 27, 2006

(51) Int. Cl. G02C 11/08; G02C 7/10

(52) U.S. Cl. 351/62; 351/44

(57) ABSTRACT

Eyewear having forehead-ventilating provisions includes a laterally-elongated slat projecting at or slightly above eye level for the wearer. The eyewear provides a solid front extending between upper and lower margins as well as left and right ends. The slat is secured to either the upper margin or else the ends of the eyewear to project, as said, forward from the solid front at or slightly above eye level. The slat defines a trailing, laterally-elongated slot. The slat and slot are cooperatively formed to divert air that is incoming on relatively level paths for the solid front—or slat—onto angled paths aimed at streaming up and/or fanning out across the wearer's forehead. The slat and slot are scaled and proportioned to enhance forehead-ventilation and refreshing-comfort to wearers active in activities in which they are rushing themselves or being rushed forward at exhilarating but not fearsome rates of travel.

### BACKGROUND AND SUMMARY OF THE INVENTION

The invention relates to eyewear and, more particularly, to eyewear having forehead-ventilating provisions. Preferably such eyewear includes without limitation goggles or, separate and apart from goggles, sunglasses and the like. In other words, preferably such eyewear is intended for persons engaging in sports, recreations or activities in which they are heading through the air at fairly swift (or faster) paces of travel and in situations where forehead ventilation would bring some comfort.

Presumptively, the comfort would be in the manner of cooling comfort. Correspondingly, the situations would include (but not exclusively so) whether riding or not a vehicle or animal. Other situations would moreover include jogging and the like. In contrast, the benefits of the forehead-ventilating provisions would be under-utilized in situations of riding in a vehicle having a windshield. It might be readily appreciated that the benefits of forehead ventilation in such activities would be most welcome on hot days.

By way of background (and without the following being any limitation of the invention), the situation which prompted the conception of the present invention was the activity of recreational sailing.

Recreational sailing is enthusiastically enjoyed over windy days with warm bright sunshine. Eyewear is not only stylish but practical too. Sunglasses or shades counter not only direct sunlight but also the glare of the dazzling reflection thereof off roughened water.

Additionally, the lenses or lens (in the case of one-piece wrap-around style lenses, or goggles) shield against spray or particulate from entering the eye(s).

However, just like thermal earmuffs—which only cover the ears to keep the whole head warm (which is fine in cold weather)—eyewear especially if wraparound and covering little more than the eye sockets tends to heat up the whole head. In other words, eyewear in accordance with the prior art can produce discomfort on warm days.

Sailing, regardless if practiced as a recreation or sport (and like other recreations and sports), has the participants generally facing a direction of travel. Hence there is a ready supply of onrushing air to harness for some measure of a cooling benefit.

It is an object of the invention to overcome the shortcomings of the prior art eyewear with an improvement which provides forehead ventilation.

One index that measures (or reports) the heat of a day is the “official” temperature. The “official” temperature is the most historical and familiar index. The “official” temperature is simply the measure that a thermometer indicates:—in the shade. But a person's “real feel” of heat (or cold) is influenced by a variety of factors. Indeed, nowadays broadcast meteorologists are introducing to the public a new way to report the feel of any given day, such as in accordance with a “RealFeel” index of temperature.

Accuweather.com is an online weather forecasting service which is spearheading the acceptability of the “RealFeel” index. Indeed, “THE REALFEEL TEMPERATURE” is covered by U.S. Service Mark Registration No. 2,238,312, owned by AccuWeather, Inc., of State College, Pa., in connection with “temperature index information services.” Presumptively, the “RealFeel” index better describes what the temperature really feels like. The “RealFeel” index is a composite of the effects of temperature, wind, humidity, sunshine intensity, cloudiness, precipitation and elevation on the human body:—everything that affects how warm or cold a person feels.

The “official” temperature by itself gives only part of the picture. Other measures, like the wind chill or heat index, include the official temperature and only one additional factor:—like wind speed for the wind chill index or humidity for the heat index.

Other limitations of the wind chill or heat indexes include that these are designed to measure effects on an inanimate object or an unclothed person. Neither the wind chill nor the heat index are perfect at informing anyone what it really feels like to an appropriately dressed person. The “RealFeel” index presumptively includes everything that better informs a person how warm or cold he or she will likely feel.

For example, on a steamy summer day with no breath of wind but with the high afternoon sun beating down, the official meteorologist-reported temperature (which is measured in the shade) might be 92° F. (˜33° C.). But when anyone of us stands outside in such a scorching sun, the actual sensation may feel more like 118° F. (˜48° C.). In contrast, in other instances when the official temperature is 92° F. (˜33° C.) except that there is also a nice breeze blowing and low humidity—still with bright sunshine but late in the day so that the sun intensity is not as strong—the actual sensation may feel more like 86° F. (30° C.).

It is therefore another object of the invention to supply an improvement in eyewear which provides forehead ventilation so as to give the wearer a more comfort on warm or hot days. Such comfort can be reckoned in the manner as the feeling of a “RealFeel” temperature which is lower than the official temperature. Alternatively, such comfort can be reckoned as combating premature over-heating for strenuous or athletic competitions or pastimes.

A number of additional features and objects will be apparent in connection with the following discussion of the drawings and preferred embodiment(s) and example(s).

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims. In the drawings,

FIG. 1 is an elevational perspective view of eyewear in accordance with the invention provided with forehead ventilation measures;

FIG. 2 is an enlarged scale perspective view thereof from an over- and behind-the-head vantage point, with portions broken away;

FIG. 3 is a top plan view thereof;

FIG. 4 is a side elevational view thereof;

FIG. 5 is an enlarged-scale sectional view taken along line 5-5 in FIG. 3;

FIG. 6 is a comparable sectional view on an enlarged-scale except taken along line 6-6 in FIG. 3;

FIG. 7 is an elevational perspective view comparable to FIG. 1 except showing an alternate embodiment of eyewear in accordance with the invention provided with forehead ventilation measures, wherein the eyewear's frame of this embodiment comprises not a full frame—with left and right eye pieces—but a half-rimless frame;

FIG. 8 is an enlarged scale perspective view—with portions broken away and from a vantage point up high in front—of an additional embodiment of eyewear in accordance with the invention provided with forehead ventilation measures, wherein instead as better shown by FIGS. 2-3 and 5-6 that the air-deflecting formation(s) is(are) provided by the slat alone this embodiment shows in contrast that the air-deflecting formation(s) is(are) cooperatively formed at the intersection between the slat and eyewear; and,

FIG. 9 is a side elevational view of FIG. 8.

### DETAILED DESCRIPTION OF THE PREFERRED EMBODIMENTS

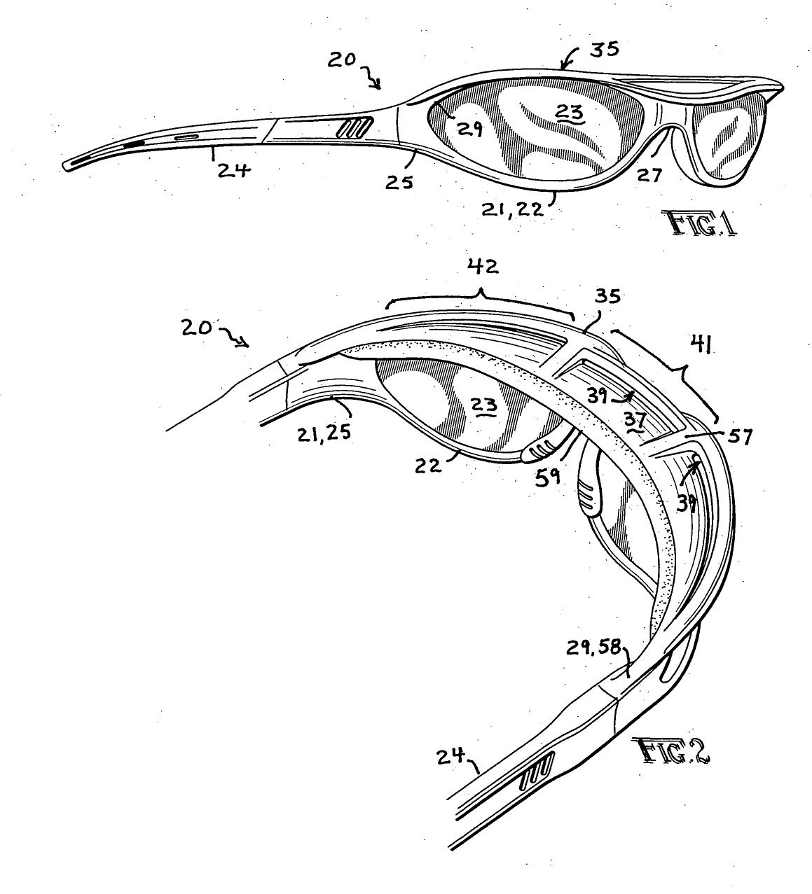

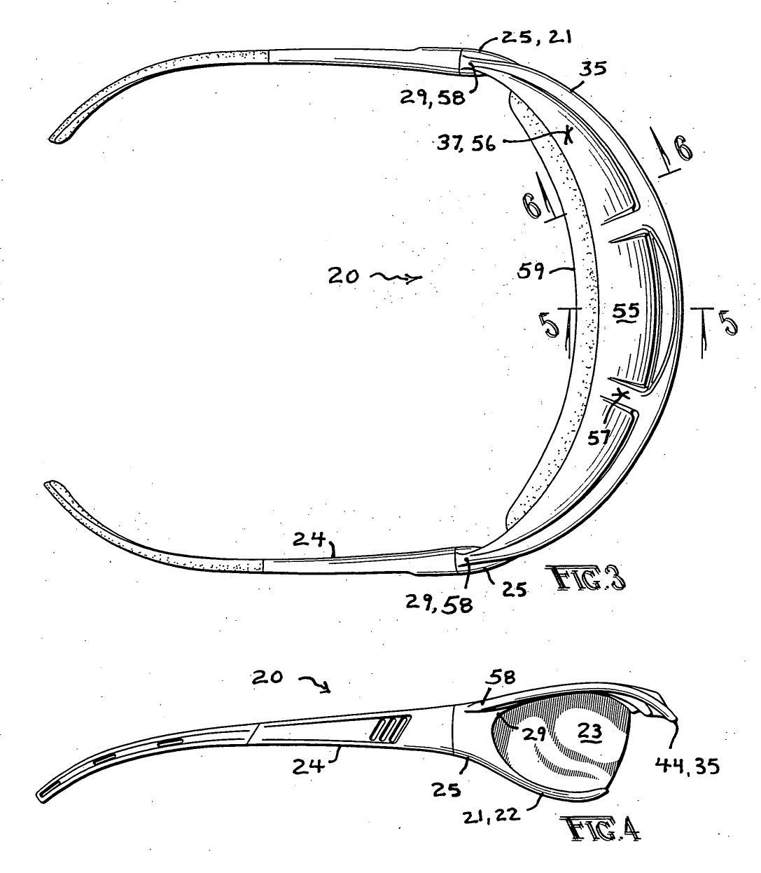

FIGS. 1 and 2 show eyewear 20 that is provided with forehead ventilation measures in accordance with the invention. This style of eyewear 20 comprises a full frame 21, which is characterized by having left and right eye pieces 22 with left and right lenses 23 affixed therein, in the left and right eye pieces 22. However, the forehead ventilation measures in accordance with the invention can be incorporated in eyewear having other frame styles without limitation, including rimless, half rimless or goggles.

Rimless frames—as well as not only some half-rimless frames and but also some goggle styles—are typically distinguished by featuring a one-piece wrap-around lens 73. FIG. 7 hereof shows an alternate embodiment of eyewear 70 provided with forehead ventilation measures in accordance with the invention, wherein the eyewear 70 of this embodiment comprises not a full frame but a half-rimless frame 71, and as more particularly described below. Goggles are more typically distinguished by featuring not temples 24 but elastic headbands (none shown). However, all the frame styles can be adapted to feature headbands rather than temples 24 and still be suitable for incorporating the forehead ventilation measures in accordance with the invention. In the drawings, only eyewear with temples 24 are shown for convenience sake and without limitation.

With general reference to FIGS. 1 though 4, this full-frame version of eyewear 20 in accordance with the invention the left and right eye pieces 22 flanked by left and right end pieces 25 and then connected by a saddle-style nose bridge 27, which defines a nasal recess.

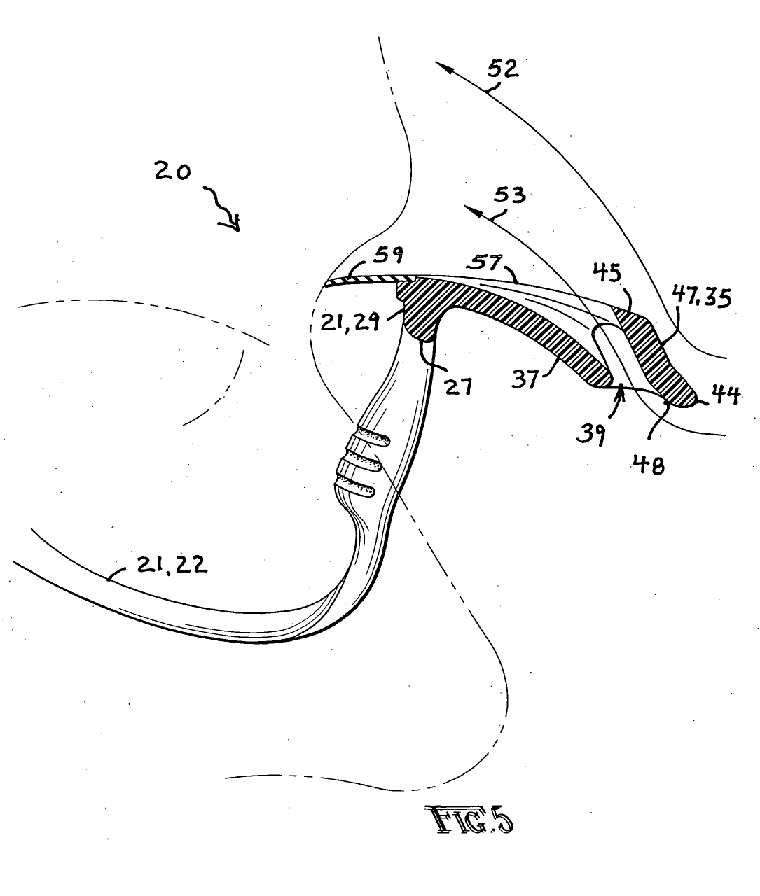

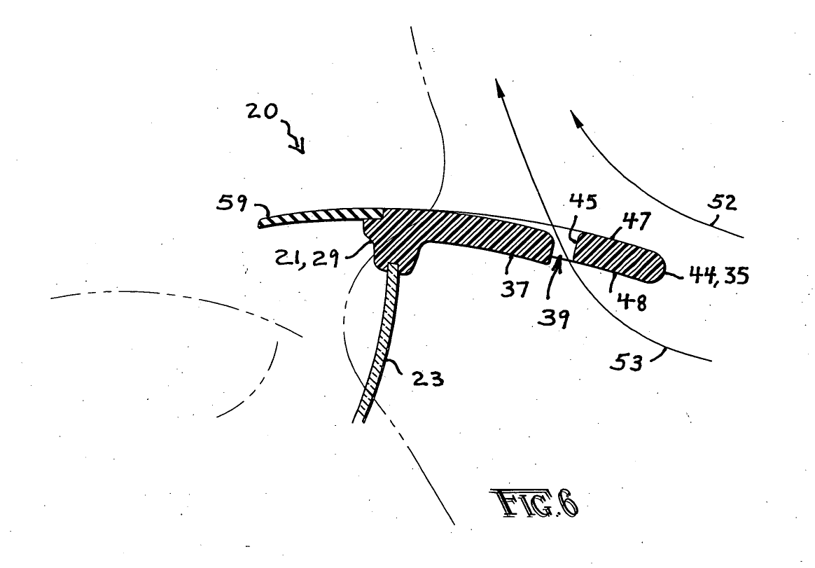

As FIGS. 1 and 4 show better, the frame 21 and lenses 23 can be reckoned as constituting a solid front for the eyewear 20. Indeed all styles of eyewear can be deemed as having a solid front, regardless if a full frame style as shown in FIGS. 1 through 4, a half-rimless style (eg., FIG. 7), rimless or goggles or whatever. In general, the solid fronts for all these styles of eyewear will extend vertically between spaced upper and lower margins as well as laterally between spaced end margins. More specifically, for the full frame eyewear 20 of FIGS. 1 through 4, the end margins are defined by the end pieces 25 and, as FIGS. 5 and 6 show better, the upper margin is defined by a top rail 29. The top rail 29 extends across the whole width of the wearer's brow, and includes the nose bridge 27 as well as the upper arches of the eye pieces 22.

It is an aspect of the invention that this eyewear 20 includes a laterally-elongated slat 35 secured to either the top rail 29 and/or end pieces 25. It is an optionally further aspect of the invention that this eyewear 20 includes an abbreviated visor 37 projecting forward from the top rail 29, which puts it somewhere between eye level and slightly above eye level.

The slat 35 defines a trailing as well as correspondingly laterally-elongated slot 39. This slat 35 and slot 39 combination are cooperatively formed to provide forehead ventilation. As shown better by FIGS. 5 and 6, one manner of providing forehead ventilation is by diverting air that is incoming on relatively level paths for the solid front and/or for the slat 35 onto angled paths aimed at streaming up and/or fanning out across the wearer's forehead.

The slat 35 is produced as a ribbon of material that arcs in a curve such that the slat 35 has a forward central span-wise portion 41 which transitions into flanking as well as trailing end span-wise portions 42. The ribbon-like slat 35 varies in cross-sectional shape but is generally rectangular, although more nearly foil-shaped at the very center. Hence the slat 35 has a leading and trailing edge 44 and 45 extending between spaced upper and lower surfaces 47 and 48.

FIG. 5 is an enlarged-scale cross-sectional view of the slat 35 and slot 39 (as well as optional visor 37) through the middle of the nose bridge 27. The leading edge 44—at least for the central span-wise portion 41—is preferably pitched down such that the leading edge 44 and upper surface 47—again, for at least the central span-wise portion 41—drive into the air that is incoming on the relatively level paths therefor and lift such onto the angled paths aimed at streaming up and/or fanning out across the wearer's forehead. Indicator arrow given reference numeral 53 illustrates air that is incoming on the relatively level paths for the slat 35's leading edge 44 and upper surface 47.

FIG. 6 is a cross-sectional view of the slat 35 and slot 39 (as well as optional visor 37) comparable to FIG. 5 except not through the middle of the nose bridge 27 but through the middle of the left eye piece 22 (and as representative of the construction of things through a slice in the right eye piece 22 as well).

FIGS. 5 and 6 together show that the slat 35's lift of the air—in particular for at least from the central span-wise portion 41—that is incoming on the relatively level paths for the slat 35 and onto the angled paths aimed at streaming up and/or fanning out across the wearer's forehead (ie., indicated by reference numeral), also causes acceleration of that same air stream over the open slot 39 and hence contributes to a pressure differential across the slot 39—with lower pressure being above—and thereby factors into the flux of air up through the slot 39 that is indeed is blocked or otherwise is about to be blocked by the eyewear 20's solid front. Accordingly, air streaming up and/or fanning out across the wearer's forehead comprises both air lifted by the slat 35 and air fluxing up through the slot 39. Air fluxing up through the slot 39 is indicated by reference numeral 53.

With general reference to FIGS. 1 though 6, the inventive eyewear 20 optionally furthermore includes the abbreviated visor 37. The visor 37 has a slender crescent shape and project forward from the top rail 29. The visor 37 terminates in an outer edge such that the slat 35 in combination with the visor 37's outer edge defines the slot 39. In other words, the slot 39 is an elongated gap between the slat 35 and visor 37.

The visor 37 comprises a medial span-wise portion 55 which transitions into left and right flanking span-wise portions 56. FIGS. 5 and 6 show in contrast that, the visor 37's medial span-wise portion 55 is pitched down at some shallow albeit a relatively steeper angle (ie., FIG. 5) than the flanking span-wise portions 56 (eg., FIG. 6), which are pitched down at some other shallow albeit relatively shallower angles. Also, as FIGS. 2-3 and 5-6 show better, the slat 35 is curved to define asymmetry with respect to the slot 39 such that the slot 39 is relatively wider behind the central span-wise portion 41 of the slat 35 and relatively narrower behind the flanking as well as trailing end span-wise portions 42 of the slat 35. The net effect thereof might be that, the air fluxing through the slot 39 for the central span-wise portion 41 of the slat 35 flows across the slat 35's lower surface 48 as the air fluxing through the slot 39 for the flanking as well as trailing end span-wise portions 42 of the slat 35 flows more nearly across the slat 35's trailing edge 45.

Persons ordinarily skilled in the art would readily appreciate numerous ways to secure the slat 35. The drawings illustrate two optional ways. FIG. 2 shows best that the slat 35 can be supported by extensions 57 intermediate its end extremes 58 thereof and/or be secured by having the end extremes 58 of the slat 35 meeting and joining the frame 21's top rail 29. It is preferred if the slat 35's forward-most projection extends about as far out as from the wearer's brow as about the distance of the wearer's nose tip.

It is preferred if the whole construction of frame 21 (excluding the temples 24), visor 37 and slat 35 is formed as a monolithic structure from a single material.

It is optionally preferred if the eyewear 20's further comprise a forehead-contacting brow-seal 59 that is secured by the frame 21's top rail 29. The brow-seal 59 is preferably produced from a soft and shape-conformable material—not only for blocking overhead light rays or for providing universal fitting of said brow-seal 59 to various shapes and sizes of brows but also—for reducing leakage of air past the seal 59. That way, the seal 59 increases the frontage of what blocks air under the slat 35 to include virtually the wearer's whole face. The seal 59 might be optionally perforated (not shown) such that it is still a substantial barrier, but does allow a tiny leak-through flow in order to fight humidity build-up in the space between the wearer's face and lens. In other words, incorporating a measure of perforation (not shown) in the seal 59 fights against lens fogging.

It is an alternate aspect of the invention that the relative pitch and spacing for the slat 35 and slot 39 respectively are chosen to provide overhead light cut-off angles to shield the wearer's eyes from direct high-angle rays of the sun. The visor 37, abbreviated as it is, after all is still a visor 37. Also, the slat 35 provides an extension for the effective reach of the visor 37. In connection with this, it is moreover optionally preferred if the eyewear 20 dually functions as sunglasses. That is, it is optionally preferred if the lens 73 or lenses 23 are tinted or coated and perhaps polarized for shading sunlight or optical glare therefrom.

Given the foregoing, it is an advantage of the eyewear 20 that it provides refreshing comfort to wearers active in activities in which they are rushing themselves or being rushed forward at swift but not fearsome rates of travel. That is, either the wearer's are moving forward under their own power, or there are being carried on vehicle such as and without limitation a sail boat. There is the alternative possibility that wind alone could be harnessed by the slat 35 and slot 39 to provide forehead ventilation. However, activities like sailing aside, many hot or warm days in the summer which are best to be outside are often also windless.

FIG. 7 shows an alternate embodiment of eyewear 70 provided with forehead ventilation measures in accordance with the invention. The style of this eyewear 70's frame 71 comprises not a full frame but a half-rimless frame 71. Nevertheless, what rim there is with this frame 71 comprises a top rail 29, visor 37, slat 35 and slot 39 construction comparable to what is shown in FIGS. 1 through 6.

FIG. 7 shows better that the nasal recess in one-piece wrap-around style lens 73 would be uncomfortably sharp unless lined with a nose piece 76, as shown. The nose piece 76 not only provides universal fitting of the eyewear 70 to various shapes and sizes of noses but also acts to constrain leakage of air past it. In consequence, the nose piece 76 effectively increases the frontage of what blocks air under the slat 35 to include virtually the wearer's whole face.

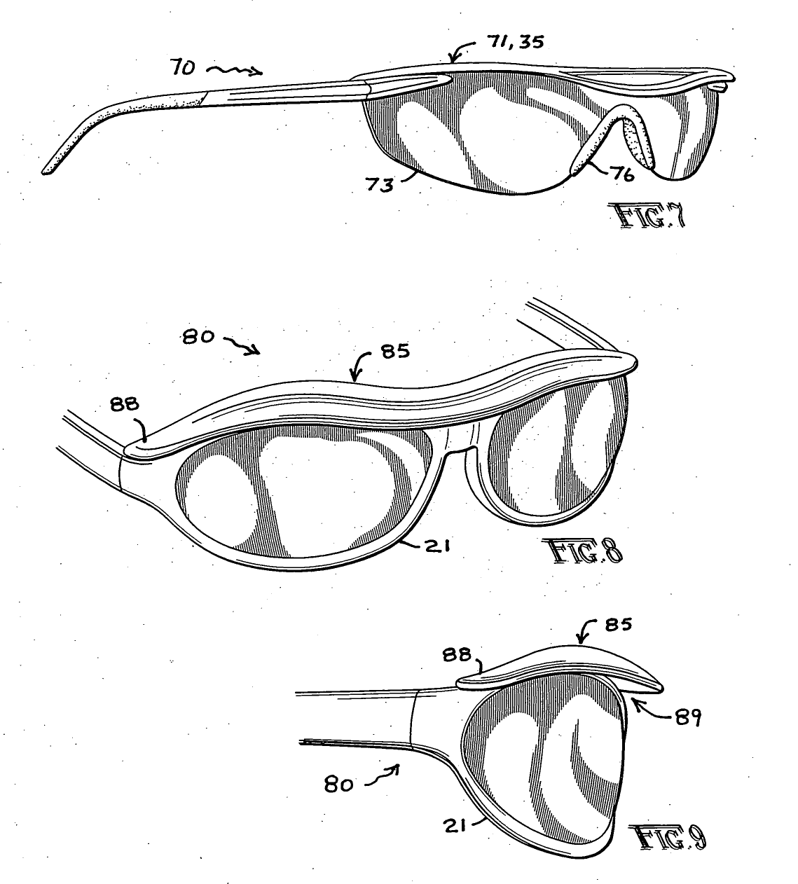

FIGS. 8 and 9 show an additional embodiment of eyewear 80 provided with forehead ventilation measures in accordance with the invention. In contrast to including a visor 37 like what FIGS. 2-3 and 5-6 show better, the air-deflecting work of the FIGS. 8 and 9 embodiment of eyewear 80 is provided by the slat 85 alone, without the visor 37. This eyewear 80 has a full frame 21 which includes a top rail (hidden from view, but see top rail 29 in FIGS. 5 or 6). The slat 85 is secured spaced away from the top rail by any of extensions (hidden from view, but see extensions 57 in FIGS. 2 or 3); end extremes 88; or the like. Given the foregoing, the slot 89 is defined between the slat 85 and the top rail (again, hidden from view, but see top rail 29 in FIGS. 5 or 6). Otherwise, the FIGS. 8 and 9 embodiment of eyewear 80 provides refreshing comfort in the manner of forehead ventilation comparably as either the FIGS. 1 or 7 versions of eyewear 20 or 70, respectively.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. Eyewear having forehead-ventilating provisions, comprising:
a solid front extending between spaced upper and lower margins as well as laterally between spaced end margins; and
a laterally-elongated slat secured to either the upper margin and/or the end margins to project the solid front forward at or slightly above eye level and define a trailing as well as laterally-elongated slot, which slat and slot are cooperatively formed to divert air that is incoming on relatively level paths for the solid front or the slat onto angled paths aimed at streaming up and/or fanning out across the wearer's forehead.

2. The eyewear of claim 1 wherein said slat comprises a ribbon of material that arcs in a curve having a forward central span-wise portion which transitions into flanking as well as trailing end span-wise portions; said ribbon comprising a leading edge and a spaced away trailing edge extending between upper and lower surfaces; the leading edge at least for the central span-wise portion being pitched down such that the leading edge and upper surface for at least the central span-wise portion drive into the air that is incoming on the relatively level paths and lift such onto the angled paths aimed at streaming up and/or fanning out across the wearer's forehead.

3. The eyewear of claim 2 wherein the slat's leading edge's and upper surface's lift of the air—at least from the central span-wise portion—that is incoming on the relatively level paths therefor, and onto the angled paths aimed at streaming up and/or fanning out across the wearer's forehead, also causes acceleration of that air over the open slot and hence contributes to a pressure differential across the slot—with lower pressure being above—and thereby factors into the flux of air up through the slot that is indeed or is about to be blocked by the eyewear's solid front, whereby air streaming up and/or fanning out across the wearer's forehead comprises both air lifted by the slat and air fluxing up through the slot.

4. The eyewear of claim 3 wherein said slat in combination with the solid front's upper margin defines the slot, which is an open seam therebetween.

5. The eyewear of claim 4 wherein the solid front comprises a one-piece wrap-around lens as well as a partially-rimless frame or fully-rimless frame.

6. The eyewear of claim 3 further comprising an abbreviated, crescent-shaped visor projecting from the solid front's upper margin, which visor has an outer edge such that said slat in combination with the visor's outer edge defines the slot, which is an elongated gap therebetween.

7. The eyewear of claim 6 wherein said visor comprises a medial span-wise portion which transitions into left and right flanking span-wise portions; and wherein the medial span-wise portion is pitched down at some shallow albeit a relatively steeper angle than the flanking span-wise portions, which are pitched down at some other shallow albeit relatively shallower angles.

8. The eyewear of claim 6 wherein the solid front comprises a full frame having left and right eye pieces as well as left and right lenses affixed in the left and right eye pieces.

9. The eyewear of claim 8 wherein the whole construction of frame, visor and slat is formed as a monolithic structure from a single material

10. The eyewear of claim 2 wherein the slat is curved to define an asymmetric slot such that the slot is relatively wider behind the central span-wise portion of the slat and relatively narrower behind the flanking as well as trailing end span-wise portions of the slat.

11. The eyewear of claim 10 wherein the eyewear's solid front blocks air that is incoming on the relatively level paths therefor and hence contributes to a pressure differential across the slot—with higher pressure being above—and thereby factors into the flux of air up through the slot that is indeed or is about to be blocked by the eyewear's solid front, whereby air streaming up and/or fanning out across the wearer's forehead comprises both air lifted by the slat and air fluxing up through the slot.

12. The eyewear of claim 10 wherein the air fluxing through the slot for the central span-wise portion of the slat flows across the slat's lower surface as the air fluxing through the slot for the flanking as well as trailing end span-wise portions of the slat flows more nearly across the slat's trailing edge.

13. The eyewear of claim 12 wherein the solid front includes a nasal recess, not only providing universal fitting of said eyewear to various shapes and sizes of noses but also to constrain leakage of air there-behind in order to increase the frontage of what blocks air under the slat to include virtually the wearer's whole face.

14. The eyewear of claim 10 wherein the solid front's upper margin further comprise a forehead-contacting brow-seal projecting rearward therefrom and formed of a soft and shape-conformable material not only for blocking overhead light rays or for providing universal fitting of said brow-seal to various shapes and sizes of brows but for also reducing leakage of air there-above in order to increase the frontage of what blocks air under the slat to include virtually the wearer's whole face.

15. The eyewear of claim 2 wherein the slat's flanking as well as trailing end span-wise portions terminate in end extremes, and the slat is supported in spaced relation relative to the solid front's upper margin by one or more laterally-spaced extensions intermediate the end extremes thereof.

16. The eyewear of claim 2 wherein the slat's flanking and trailing end spans terminate in end extremes, and the slat is supported in spaced relation relative to the solid front's upper margin by the end extremes being anchored in the solid front.

17. The eyewear of claim 2 wherein the relative pitch and spacing for the slat and slot respectively are chosen to provide overhead light cut-off angles to shield the wearer's eyes from direct high-angle rays of the sun.

18. The eyewear of claim 2 wherein slat's leading edge for the flanking as well as trailing end span-wise portions is pitched down at a relatively shallow angle.

19. The eyewear of claim 1 wherein the slat is fixed, and so thereby also the slot, such that the scale and proportions thereof are chosen to enhance forehead-ventilation thereto and refreshing-comfort therefrom to wearers active in activities in which they are rushing themselves or being rushed forward at exhilarating not fearsome rates of travel.

20. The eyewear of claim 19 wherein the scale and proportions of the slat and slot are more particularly chosen to enhance forehead-ventilation to wearers thereof and refreshing-comfort thereto engaged in active in activities in warm or warmer and not cool temperatures.

22. The eyewear of claim 1 wherein the slot's forward extreme extends about as far out as from the wearer's brow as about the distance of the wearer's nose tip.

23. The eyewear of claim 1 wherein the solid front comprises a lens or lenses provided with tinting, coatings or polarization for shading sunlight or optical glare therefrom.
